(19) United States
(12) Patent Application Publication
(10) Pub. No.: US 2026/0145447 A1
(43) Pub. Date: May 28, 2026

(54) SHEET CONVEYANCE APPARATUS AND IMAGE FORMING SYSTEM

(71) Applicant: CANON KABUSHIKI KAISHA, Tokyo (JP)

(72) Inventor: AKIHIRO ITO, Chiba (JP)

(21) Appl. No.: 19/394,778

(22) Filed: Nov. 19, 2025

(30) Foreign Application Priority Data
Nov. 28, 2024 (JP) 2024-207130

(51) Int. Cl. B41J 13/26; B41J 13/03; B41J 13/14

(52) U.S. Cl. CPC B41J 13/26; B41J 13/03; B41J 13/14

(57) ABSTRACT

A sheet conveyance apparatus includes a housing and a detachable unit that is detachable from the housing. The detachable unit includes a conveyance unit and a support unit that supports the conveyance unit. The conveyance unit includes a conveyance roller pair that nips and conveys a sheet and includes a guide pair that guides the sheet. The support unit has an opening at one end in a width direction that is perpendicular to a sheet conveyance direction, and the conveyance unit is detached from the support unit by moving in the width direction and passing through the opening.

### BACKGROUND

### Field of the Technology

The present disclosure relates to a sheet conveyance apparatus for conveying a sheet and an image forming system to which the sheet conveyance apparatus is applied.

### Description of the Related Art

Inkjet or electrophotographic image forming apparatuses including a registration unit have been widely used. The registration unit corrects skew of a sheet and the position of the sheet relative to an image in the width direction perpendicular to a sheet conveyance direction before printing or image transfer is performed. For example, the configuration of a registration unit has been proposed that corrects the position of a sheet in the width direction of a sheet by moving a roller in the width direction (refer to, for example, Japanese Patent Laid-Open No. 2023-80389). This registration unit includes a registration roller pair and corrects the position of a sheet in the width direction by moving the registration roller pair in the width direction.

In this case, for example, it may be necessary to remove the registration roller pair when maintenance, such as replacement of the registration roller pair, is performed. However, according to the registration unit described in Japanese Patent Laid-Open No. 2023-80389, when a registration roller pair is removed, it is difficult to extract the registration roller pair because the registration roller pair is in contact with a support frame in the width direction. For this reason, it may be necessary to disassemble the support frame of the registration unit, which reduces workability.

### SUMMARY

The present disclosure is directed to a sheet conveyance apparatus and an image forming system that can improve workability in maintenance or the like of a conveyance unit that conveys a sheet.

According to some embodiments of the present disclosure, there is provided a sheet conveyance apparatus including a housing and a detachable unit configured to be detachable from the housing, wherein the detachable unit includes a conveyance unit and a support unit configured to support the conveyance unit, wherein the conveyance unit includes a conveyance roller pair configured to nip and convey a sheet, and a guide pair configured to guide the sheet, wherein the support unit has an opening at one end in a width direction that is perpendicular to a sheet conveyance direction, and wherein the conveyance unit is detached from the support unit by moving in the width direction and passing through the opening.

According to another aspect of the present disclosure, there is provided an image forming system including an image forming apparatus and the sheet conveyance apparatus described above, where the image forming apparatus includes an image forming unit configured to form an image on a sheet.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of an image forming system according to a first embodiment.

FIG. 2 is a cross-sectional view of a drying module according to the first embodiment.

FIG. 3A is a perspective view of a registration unit as viewed from the upper right front, according to the first embodiment.

FIG. 3B is a perspective view of the registration unit as viewed from the upper left front, according to the first embodiment.

FIG. 4A is a perspective view of a conveyance unit as viewed from the upper right front, according to the first embodiment.

FIG. 4B is a perspective view of the conveyance unit as viewed from the upper left front, according to the first embodiment.

FIG. 5 is a back view of the registration unit according to the first embodiment.

FIG. 6 is a perspective view of the registration unit according to the first embodiment.

FIG. 7 is a back view of a registration unit according to a second embodiment.

### DESCRIPTION OF THE EMBODIMENTS

### First Embodiment

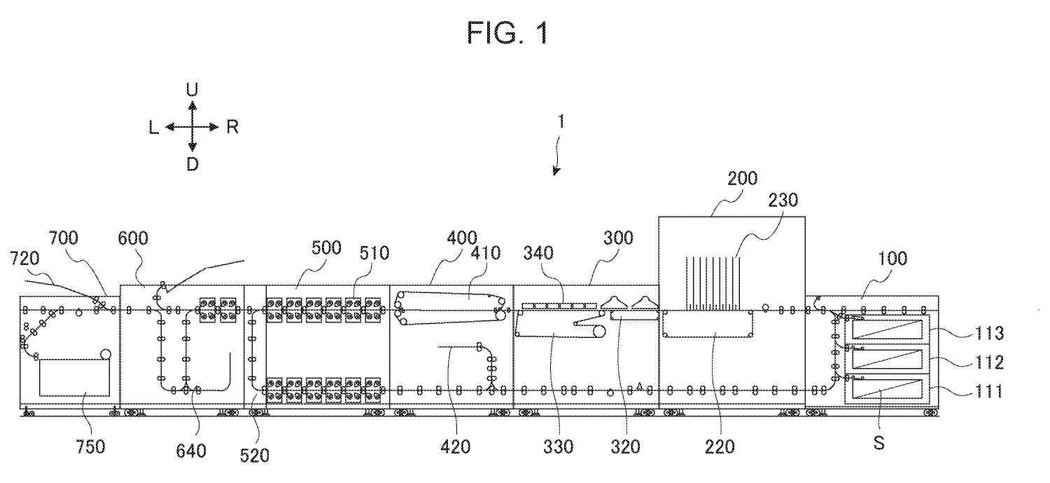

The first embodiment is described below with reference to FIGS. 1 to 6. According to the present embodiment, an image forming system is applied to an inkjet printing system 1. FIG. 1 is a schematic illustration of an example of the configuration of the inkjet printing system 1. The inkjet printing system 1 is a sheet-fed inkjet printing system that uses two types of liquid, a reaction fluid and ink, and forms an ink image on a sheet S to produce a printed matter. As illustrated in FIG. 1, the inkjet printing system 1 includes a feed module 100, a print module 200, a drying module 300, a fixing module 400, a cooling module 500, a reversing module 600, and a discharge module 700. The sheet S, which is a cut paper sheet supplied from the feed module 100, is conveyed along a conveyance path, is processed in each of the modules, and is discharged by the discharge module 700.

According to the present embodiment, each of the feed module 100 to the discharge module 700 includes a separate housing, and these housings are connected to each other to form the inkjet printing system 1. However, the present embodiment is not limited thereto. The feed module 100, the print module 200, the drying module 300, the fixing module 400, the cooling module 500, the reversing module 600, and the discharge module 700 may be disposed in a single housing. According to the present embodiment, a sheet is a printing medium that includes paper, such as a paper sheet or envelope, a plastic film, such as overhead projector sheet (OHP), and cloth. In addition, according to the present embodiment, the sheet is disposed such that a sheet conveyance direction D1 extends in the left-right direction of the inkjet printing system 1. As used herein, the direction toward the right side of the inkjet printing system 1 is referred to as "right direction R", the direction toward the left side as "left direction L". The direction extending forward from the front side of the inkjet printing system 1 is referred to as "forward direction F", the direction extending toward the back side as "backward direction B", the direction extending toward the upper side as "upward direction U", and the direction extending toward the lower side as "downward direction D".

The feed module 100 is connected to the print module 200 and conveys and delivers a sheet to the print module 200. The feed module 100 includes a first feeding unit 111, a second feeding unit 112, and a third feeding unit 113 as sheet feeding units that contain and feed the sheet S. The number of feeding units is not limited to three. The feed module 100 may be configured to include one, two, or four or more feeding units. The feed module 100 is described in more detail below.

The print module 200 is an example of an image forming apparatus and includes a pre-image formation registration correction unit (not illustrated), a print belt unit 220, and a print unit 230 to convey the sheet S. The sheet S conveyed from the feed module 100 is subjected to inclination and position correction by the pre-image formation registration correction unit and is conveyed to the print belt unit 220. The print unit 230 is disposed to face the print belt unit 220 in the conveyance path. The print unit 230 is an example of an image forming unit and forms an image on the sheet S by performing a printing (recording) process on the sheet S from above with a print head. A plurality of print heads are aligned in the conveyance direction. According to the present embodiment, the print unit 230 includes a total of five line-type print heads corresponding to four colors (Y (yellow), M (magenta), C (cyan), and Bk (black)) and a reaction fluid. However, the numbers of colors and print heads are not limited to four and five, respectively. The inkjet technique may be a technique using a heater element, a piezo element, an electrostatic element, a MEMS element, or the like. Ink of each color is supplied from an ink tank (not illustrated) to the print head via an ink tube. The ink contains 0.1 to 20.0 mass% resin component per the total mass of the ink, water, water-soluble organic solvent, colorants, wax, additives, and the like.

The sheet S printed in the print unit 230 is conveyed by the print belt unit 220 using suction while ensuring clearance from the print head. Misalignment and color density of an image formed on the sheet S printed in the print unit 230 are detected by an in-line scanner (not illustrated) disposed downstream of the print unit 230 in the sheet conveyance direction. The result of detection is used to correct a printed image.

The drying module 300 includes a decoupling unit 320, a drying belt unit 330, and a hot air supply unit 340 to reduce the liquid content in the ink applied to the sheet S in the print unit 230 of the print module 200 and to improve the fixability of the ink to the sheet S. The sheet S printed in the print unit 230 of the print module 200 is conveyed to the decoupling unit 320 that is disposed upstream of the drying module 300 in the sheet conveyance direction. In the decoupling unit 320, the sheet S can be conveyed using the air pressure applied from above and the friction between the sheet S and a belt. The sheet S is loosely held on the belt and is conveyed to prevent displacement of the sheet S on the print belt unit 220 that forms an ink image. The drying belt unit 330 is disposed below the belt, and the hot air supply unit 340 is disposed above the belt, with both units facing each other across the belt. The sheet S conveyed from the decoupling unit 320 is conveyed by the drying belt unit 330 using suction, and concurrently, the ink-applied surface is dried by receiving hot air from the hot air supply unit 340. To dry the ink-applied surface, in addition to supplying hot air, electromagnetic waves (such as ultraviolet or infrared rays) may be emitted to the surface of the sheet S, or a heating element may be brought into contact with the sheet S (conduction heat transfer).

If an ink portion applied to the sheet S absorbs the ink, the sheet S is partially stretched and, thus, wrinkled (that is, cockling occurs). However, the drying module 300 can heat the ink and reaction solution applied to the sheet S to promote evaporation of moisture, which reduces cockling. From the viewpoint of energy efficiency, it is desirable that a heater that heats the air be a heater using, for example, an electric heating wire or infrared rays.

The fixing module 400 includes a fixing belt unit 410. The fixing belt unit 410 includes an upper belt unit and a lower belt unit. The fixing module 400 allows the sheet S conveyed from the drying module 300 to pass between the upper belt unit and lower belt unit that are heated to fix the ink onto the sheet S.

The cooling module 500 includes a plurality of cooling units 510 to cool the high-temperature sheet S that is conveyed from the fixing module 400 along the sheet conveyance path. Each of the cooling units 510 is configured to cool the sheet S by drawing the outside air into a cooling box with a fan, increasing the pressure in the cooling box, and blowing the air from nozzles formed on a conveyance guide to the sheet S. The cooling units 510 are disposed both above and below the sheet conveyance path to cool the sheet S from both sides.

The cooling module 500 includes a conveyance path switching unit 520 that can switch the conveyance path of the sheet S depending on whether the sheet S is conveyed to the reversing module 600 or to a both-sided conveyance path used for both-sided printing. For both-sided printing, the sheet S is conveyed to the conveyance path in the lower portion of the cooling module 500. In this case, the sheet S is further conveyed from the cooling module 500 along the both-sided conveyance path in the fixing module 400, the drying module 300, the print module 200, and the feed module 100. The both-sided conveyance path in the fixing module 400 is provided with a first reversing unit 420 that flips the sheet S over. The sheet S is then conveyed again from the feed module 100 to the pre-image formation registration correction unit, the print belt unit 220, and the print unit 230 of the print module 200, where the sheet S is printed.

The reversing module 600 includes a second reversing unit 640 that can reverse the front and back of the sheet S being conveyed and change the front and back orientation of the sheet S to be discharged. The discharge module 700 includes a top tray 720 and a stacking unit 750. The discharge module 700 aligns and stacks the sheet S conveyed from the reversing module 600.

### Drying Module

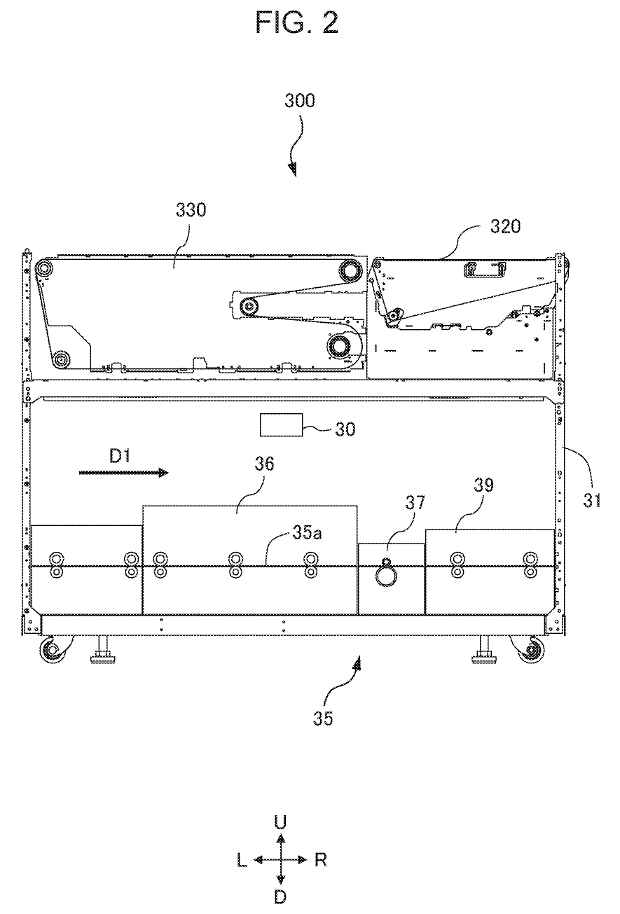

The configuration of the drying module 300 is described below with reference to FIG. 2. The drying module 300 is an example of a sheet conveyance apparatus that conveys the sheet S. The drying module 300 includes a housing 31, the decoupling unit 320, the drying belt unit 330, a both-sided conveyance unit 35, and a control unit 30. The decoupling unit 320 and the drying belt unit 330 are housed and supported by the upper portion of the housing 31, while the both-sided conveying unit 35 is housed and supported by the lower portion of the housing 31.

The both-sided conveyance unit 35 includes a horizontal sheet conveyance path 35a, and the sheet conveyance direction D1 extends in the right direction R. The both-sided conveyance unit 35 includes, in order from the upstream side in the sheet conveyance direction D1, a pre-registration unit 36, a both-sided registration unit 37 (hereinafter, referred to as a "registration unit 37"), and a conveyance unit 39. The pre-registration unit 36 is an example of an upstream unit. The pre-registration unit 36 is disposed directly upstream of the registration unit 37 in the sheet conveyance direction D1 and conveys a sheet to the registration unit 37. The conveyance unit 39 is an example of a downstream unit. The conveyance unit 39 is disposed directly downstream of the registration unit 37 in the sheet conveyance direction D1 and receives the sheet S conveyed from the registration unit 37.

When an image is formed on the front surface of the sheet S and, thereafter, the sheet S is conveyed in a both-sided conveyance section after passing through the conveyance path switching unit 520 in the sheet conveyance direction D1, skew of the sheet S may occur. The registration unit 37 performs skew correction of the sheet S. Thus, the registration unit 37 ensures that the amount of skew correction is within the allowable range of the pre-image formation registration correction unit during back-side image formation performed in the print module 200. The pre-registration unit 36 includes a drive roller and a driven roller. The pre-registration unit 36 can separate the driven roller from the drive roller by using a cam mechanism (not illustrated) to release the nip between the rollers. This makes it possible to avoid operation interference when the sheet S is shifted in a registration correction operation described below.

The pre-registration unit 36 and the conveyance unit 39 are disposed to overlap the registration unit 37 as viewed from the horizontal direction, for example, in the right direction R or left direction L. The decoupling unit 320 corresponds to an upper side unit disposed above the registration unit 37. Therefore, the registration unit 37 is disposed in the lower portion of the housing 31 with other units disposed on the left, right, and upper sides thereof. For this reason, it is difficult to extract the registration unit 37 from the registration unit 37 in the left-right direction or the up-down direction during maintenance of the registration unit 37 and, therefore, the registration unit 37 is extracted to the front side. According to the present example, a front side plate 373 of the registration unit 37 is screwed to the housing 31. By removing the screws disposed on the front side of the drying module 300, the registration unit 37 can be extracted to the front side. That is, the pre-registration unit 36, the registration unit 37, the conveyance unit 39, and other conveyance units in the both-sided conveyance path can be attached to and detached from the housing 31 of the drying module 300 in the forward direction F.

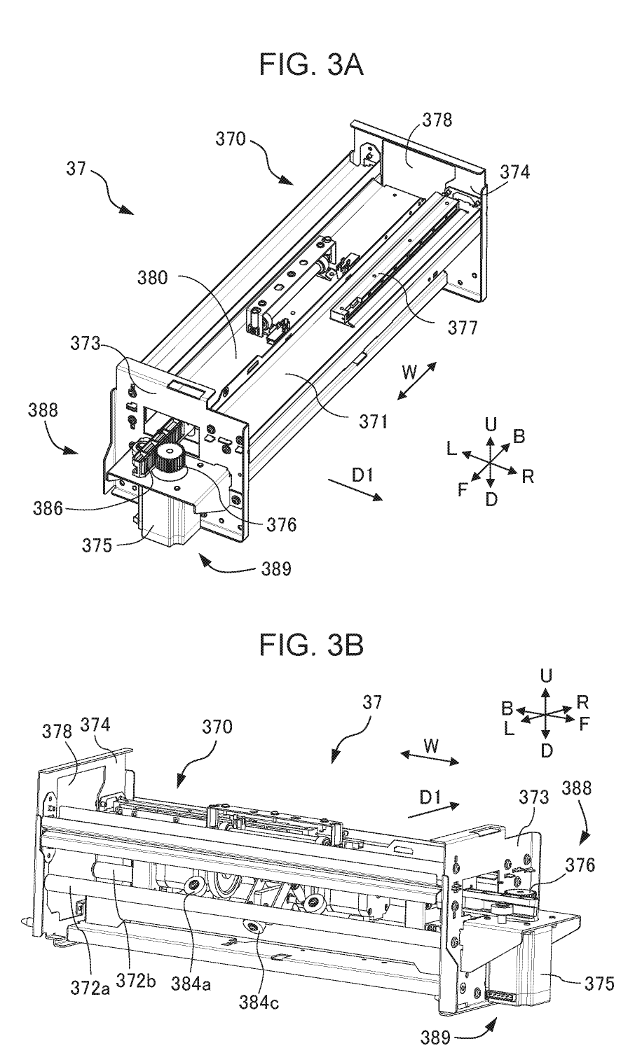

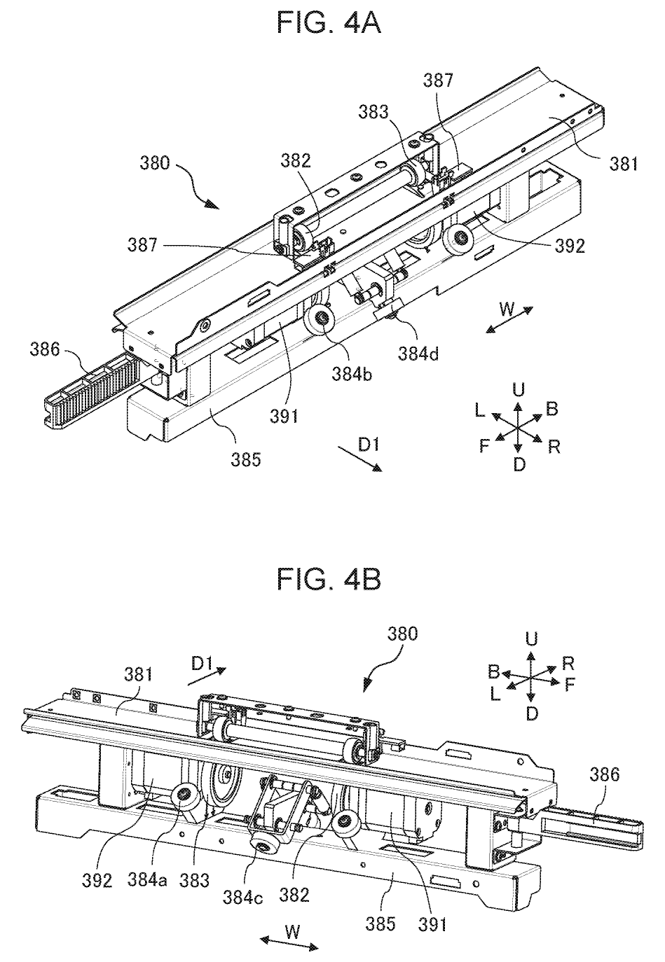

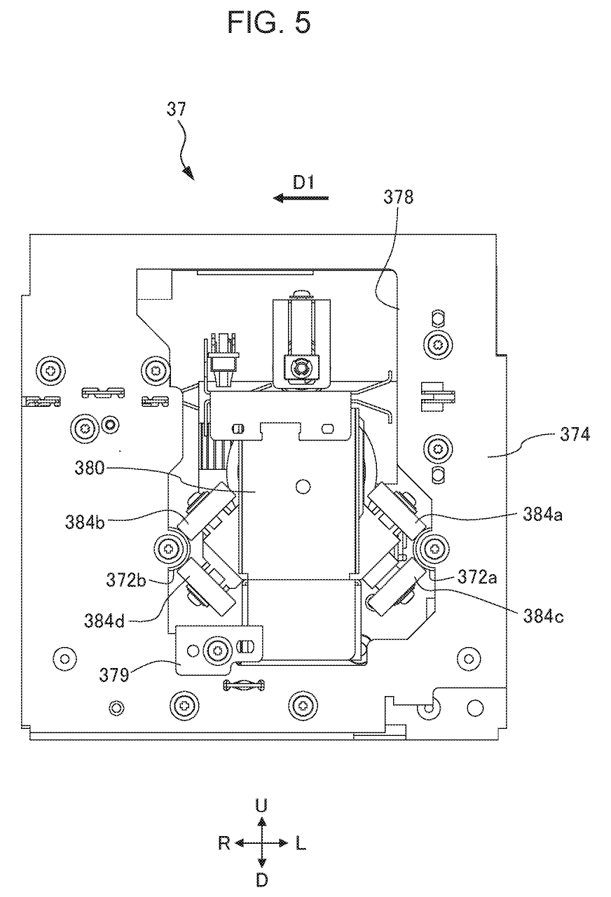

The registration unit 37 is described in detail below with reference to FIGS. 3A to 5. FIGS. 3A and 3B are perspective views of the registration unit 37, and FIGS. 4A and 4B are perspective views of a conveyance unit 380. FIG. 5 is a back view of the registration unit 37. The registration unit 37 includes a support unit 370 removably mounted to the housing 31 and the conveyance unit 380 that is removably supported by the support unit 370 and that conveys the sheet S in the sheet conveyance direction D1.

The support unit 370 includes a conveyance guide pair 371, a first rail 372a, a second rail 372b, a front side plate 373, and a back side plate 374. The conveyance guide pair 371, the first rail 372a, and the second rail 372b have the longitudinal direction that extends in the width direction W perpendicular to the sheet conveyance direction D1. The front side plate 373 and the back side plate 374 are provided on either end of each of the conveyance guide pair 371, the first rail 372a, and the second rail 372b in the width direction W to support the conveyance guide pair 371, the first rail 372a, and the second rail 372b. The back side plate 374 is an example of a side edge member provided at the back end, which is one end in the width direction W. According to the present embodiment, the case is described in which the conveyance guide pair 371, the first rail 372a, and the second rail 372b are supported by the front side plate 373 and the back side plate 374, which are plate-shaped members, at either end in the width direction W.

However, the shape of the members is not limited thereto. The front side plate 373 and the back side plate 374 (side edge members) may be, for example, block-shaped or frame-shaped members.

The first rail 372a is an example of a rail or a guide unit. The first rail 372a is disposed upstream of the center of the conveyance unit 380 in the sheet conveyance direction D1 and is attached to the support unit 370 to support the conveyance unit 380 in a movable manner in the width direction W. The second rail 372b is disposed downstream of the center of the conveyance unit 380 in the sheet conveyance direction D1 and is attached to the support unit 370 to support the conveyance unit 380 in a movable manner in the width direction W.

The conveyance unit 380 includes a registration guide pair 381, a front registration roller pair 382, a back registration roller pair 383, a first rail roller 384a, a second rail roller 384b, a third rail roller 384c, a fourth rail roller 384d, and a registration roller support base 385. The front registration roller pair 382 is an example of a first conveyance roller pair that nips and conveys the sheet S. The back registration roller pair 383 is an example of a second conveyance roller pair and is disposed at a different position from the front registration roller pair 382 in the width direction W. The back registration roller pair 383 also nips and conveys the sheet S. According to the present embodiment, the front registration roller pair 382 and the back registration roller pair 383 are coaxially disposed.

The first rail roller 384a is an example of each of a first roller, a roller, or a guided portion and is disposed above the center of the first rail 372a. The first rail roller 384a is attached to the conveyance unit 380. The first rail roller 384a is in rotatable contact with the first rail 372a and is supported by the first rail 372a in a movable manner in the width direction W. The second rail roller 384b is an example of a second roller. The second rail roller 384b is disposed above the center of the second rail 372b and is attached to the conveyance unit 380. The second rail roller 384b is in rotatable contact with the second rail 372b and is supported by the second rail 372b in a movable manner in the width direction W. The third rail roller 384c is an example of a third roller and is attached to the conveyance unit 380. The third rail roller 384c is disposed below the center of the first rail 372a so as to be in rotatable contact with the first rail 372a. The third rail roller 384c and the first rail roller 384a sandwich the first rail 372a. The fourth rail roller 384d is an example of a fourth roller and is attached to the conveyance unit 380. The fourth rail roller 384d is disposed below the center of the second rail 372b so as to be in rotatable contact with the second rail 372b. The fourth rail roller 384d and the second rail roller 384b sandwich the second rail 372b.

This configuration enables the conveyance unit 380 to perform a shift operation along the first rail 372a and the second rail 372b extending in the width direction W. The first rail roller 384a and the second rail roller 384b ride on the first rail 372a and the second rail 372b, respectively, to support the weight of the conveyance unit 380, and the rotation of the first rail roller 384a and second rail roller 384b causes the conveyance unit 380 to perform the shift operation. The third rail roller 384c and the fourth rail roller 384d are urged against the first rail 372a and the second rail 372b, respectively, by an urging mechanism. Therefore, the third rail roller 384c and the first rail roller 384a sandwich the first rail 372a, and the fourth rail roller 384d and the second rail roller 384b sandwich the second rail 372b. Thus, the conveyance unit 380 is positioned with respect to the first rail 372a and the second rail 372b in the vertical direction and is shifted, which improves the accuracy of position correction in the width direction.

The registration unit 37 includes a drive unit 388 that moves the conveyance unit 380 in the width direction W relative to the support unit 370. The drive unit 388 includes a drive section 389 and a rack gear 386. The drive section 389 includes a drive motor 375 attached to the support unit 370 and a pinion gear 376 attached to a drive shaft of the drive motor 375. The rack gear 386 is attached to the conveyance unit 380, and the pinion gear 376 is meshed with the rack gear 386 when the conveyance unit 380 is supported by the support unit 370.

The registration unit 37 includes a contact image sensor (CIS) 377 that detects the position (in the width direction) of the sheet S conveyed by the conveyance unit 380 and a control unit 30 (refer to FIG. 2) that controls the drive unit 388. The CIS 377 is an example of a width-direction detection unit and is disposed in the conveyance guide pair 371. The control unit 30 performs a shift operation by controlling the drive unit 388 to change the position (in the width direction) of the sheet S conveyed by the conveyance unit 380 based on the detection result of the CIS 377.

The conveyance unit 380 includes a first roller drive unit 391 that drives the front registration roller pair 382 and a second roller drive unit 392 that drives the back registration roller pair 383. The first roller drive unit 391 and the second roller drive unit 392 use drive motors coupled to the drive rollers of the front registration roller pair 382 and the back registration roller pair 383, respectively. According to the present embodiment, the case where each of the roller pairs is directly coupled to the drive motor is described. However, the configuration is not limited thereto. The roller pair may be coupled to the drive motor via a gear train or the like.

The registration unit 37 includes a skew detection unit 387 that detects skew of the sheet S conveyed by the conveyance unit 380. The skew detection unit 387 uses two optical sensors arranged side by side in the width direction W in the registration guide pair 381 to detect the passage of the leading edge of the sheet S being conveyed. Thus, the skew detection unit 387 can detect the skew of the sheet S based on the difference between the detection times. The control unit 30 performs the skew correction operation by controlling the first roller drive unit 391 and the second roller drive unit 392 to correct the skew of the sheet S conveyed by the conveyance unit 380 based on the detection result of the skew detection unit 387.

### Skew Correction

The skew correction is performed in two stages. In the first stage, a leading edge angle correction is performed. The skew detection units 387 provided in the registration guide pair 381 detect the leading edge of the sheet S conveyed in the conveyance direction. The control unit 30 obtains the angle component with respect to the width direction W based on the difference between the times the leading edge passes through the skew detection units 387 and, thereafter, obtains the leading edge angle correction amount. The leading edge angle of the sheet S is corrected by providing a difference in conveyance speed between the front registration roller pair 382 and the back registration roller pair 383, which are coaxially arranged in the width direction W, and thus, rotating the sheet S. The front registration roller pair 382 and the back registration roller pair 383 are rotated by, respectively, the first roller drive unit 391 and the second roller drive unit 392, which are separate drive trains, so that a speed difference can be introduced.

After the first stage of leading edge angle correction is completed, the second stage of position correction in the width direction is performed. In the position correction in the width direction, the CIS 377 reads the end position of the sheet S in the width direction, and the control unit 30 obtains the difference in distance between the end position and the target end position of the inkjet printing system 1. To correct the difference in distance, the control unit 30 operates the drive motor 375 described above to move the conveyance unit 380 in the width direction W. The control unit 30 thus performs the position correction in the width direction W. During the correction, the sheet S is nipped by the front registration roller pair 382 and the back registration roller pair 383 and, thus, the sheet S moves as the conveyance unit 380 moves in the width direction W.

The two-stage correction is performed in an interval from the time the sheet S is nipped by the front registration roller pair 382 and the back registration roller pair 383 until the sheet S is nipped by the subsequent downstream conveyance rollers and an interval in which the conveyance rollers of the pre-registration unit 36 are separated from each other. This prevents a movement failure and damage to the sheet S when the sheet S rotates or moves in the width direction W. According to the present embodiment, the skew correction is performed using the difference in rotational speed between the roller pairs. However, the configuration is not limited thereto. For example, the roller pairs may be stopped, and the leading edge of the sheet comes into contact with the roller pairs to correct skew. In addition, the registration unit 37 does not necessarily perform both a skew correction and a position correction in the width direction. The registration unit 37 may perform only the position correction in the width direction.

### Issues in Maintenance and Related Operations

Suppose, for example, that in the registration unit 37 described above, a malfunction occurs in any one of the roller drives, and the maintenance work of replacing a roller drive motor is desired. In this case, the roller drive motor cannot be removed without removing the conveyance unit 380 from the support unit 370. To replace the roller drive motor, the operation to remove the first rail 372a and the second rail 372b by which the conveyance unit 380 is held on the support unit 370 may be performed. Since the first rail 372a and the second rail 372b are held by the front side plate 373 and the back side plate 374 of the support unit 370, it may be useful to remove one of the side plates. This deteriorates the workability for separating the conveyance unit 380 and increases man-hours, resulting in an increase in running cost of the apparatus.

Therefore, according to the present embodiment, an opening 378 is provided in the back side plate 374, as illustrated in FIG. 5. The opening 378 is wider than the contour of the conveyance unit 380 as viewed from the width direction W, so that the conveyance unit 380 can be separated from the registration unit 37 through the opening 378. That is, the opening 378 is an example of a passage hole portion. The opening 378 is formed at one end (back end) of the support unit 370 in the width direction W and allows the supported conveyance unit 380 to pass therethrough in the width direction W and to be removed from the support unit 370. According to the present embodiment, when the conveyance unit 380 is supported by the support unit 370, the conveyance unit 380 overlaps the opening 378 as viewed from the width direction W.

According to the present embodiment, the conveyance unit 380 overlaps the opening 378 as viewed from the width direction W when the conveyance unit 380 is supported by the support unit 370. However, the configuration is not limited thereto. For example, suppose that the conveyance unit 380 has a variable portion having the outer surface that is easily deformed, and the variable portion overlaps the back side plate 374 excluding the opening 378 as viewed from the width direction W when the conveyance unit 380 is supported by the support unit 370. In this case, the variable portion can be deformed when the conveyance unit 380 is extracted through the opening 378. This enables easy extraction of the conveyance unit 380.

According to the present embodiment, when the conveyance unit 380 is extracted from the support unit 370, the entire conveyance unit 380 can pass through the opening 378 without touching the back side plate 374. That is, when the conveyance unit 380 is supported by the support unit 370, the first rail roller 384a, the second rail roller 384b, the third rail roller 384c, and the fourth rail roller 384d overlap the opening 378 as viewed from the width direction W. In addition, when the conveyance unit 380 is supported by the support unit 370, a portion of the first rail 372a that is in contact with at least the first rail roller 384a and the third rail roller 384c overlaps the opening 378 as viewed from the width direction W. Furthermore, when the conveyance unit 380 is supported by the support unit 370, a portion of the second rail 372b that is in contact with at least the second rail roller 384b and the fourth rail roller 384d overlaps the opening 378 as viewed from the width direction W. Still furthermore, when the conveyance unit 380 is supported by the support unit 370, the rack gear 386, the CIS 377, and the skew detection unit 387 overlap the opening 378 as viewed from the width direction W. Yet still furthermore, when the conveyance unit 380 is supported by the support unit 370, the front registration roller pair 382, the back registration roller pair 383, the first roller drive unit 391, and the second roller drive unit 392 overlap the opening 378 as viewed from the width direction W.

As illustrated in FIG. 5, the registration unit 37 includes a stopper 379 at the back end. The stopper 379 is an example of a restricting unit and is movable to one of a restricting position where the conveyance unit 380 is restricted from moving in the width direction W and a retracted position where the conveyance unit 380 is not restricted from moving in the width direction W. When at the restricting position, the stopper 379 restricts the movement of the conveyance unit 380 so that the conveyance unit 380 does not become dislodged from the support unit 370. According to the present embodiment, the stopper 379 is screwed to the lower part of the back side plate 374 at the restricting position to partially block the opening 378. At the retracted position, the stopper 379 is removed from the back side plate 374 to fully open the opening 378. That is, when at the restricting position, the stopper 379 is attached to the support unit 370 and at least partially overlaps the opening 378 as the support unit 370 is viewed from the width direction W. When at the retracted position, the stopper 379 does not overlap the opening 378 as the support unit 370 is viewed from the width direction W.

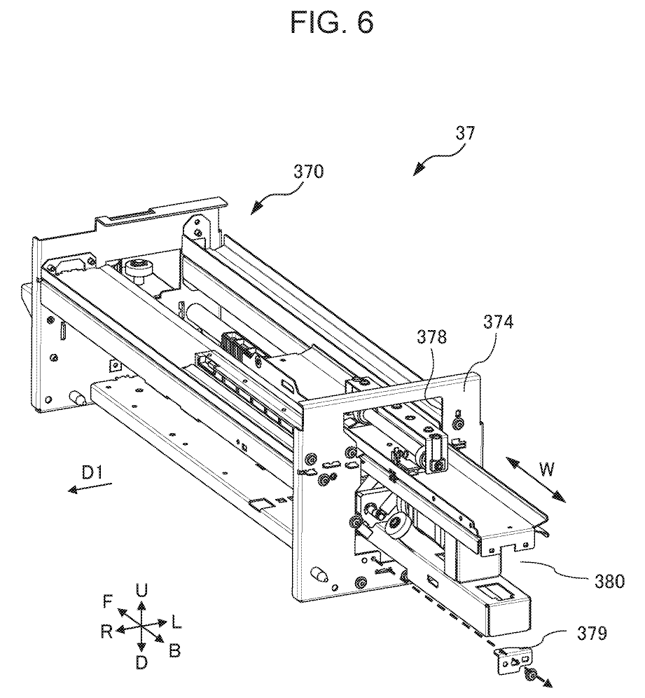

FIG. 6 is a perspective view of the conveyance unit 380 that is being extracted from the support unit 370. When the conveyance unit 380 is removed from the support unit 370, the stopper 379 that prevents dislodging of the conveyance unit 380 is removed and, thereafter, the conveyance unit 380 is extracted in the width direction W. Thus, the conveyance unit 380 can be separated.

While the present embodiment has been described with reference to the case in which the stopper 379 is a member that is attached to and detached from the back side plate 374 by screwing, the present embodiment is not limited thereto. For example, the stopper 379 may be a member that is attached to the back side plate 374 in a rotatable manner between the restricting position and the retracted position. Alternatively, while the present embodiment has been described with reference to the case in which the stopper 379 is mounted on the side adjacent to the support unit 370, the present embodiment is not limited thereto. The stopper 379 may be attached on the side adjacent to the conveyance unit 380. In this case, the stopper attached to the conveyance unit 380 is brought into contact with the back side plate 374 or another constituent member of the support unit 370 to prevent the conveyance unit 380 from dislodging.

As described above, according to the present embodiment, the opening 378 is provided in the back side plate 374, which constitutes the support unit 370, to allow the conveyance unit 380 to pass therethrough when the conveyance unit 380 is attached or detached. This makes it possible to attach or detach the conveyance unit 380 without disassembling the support unit 370 (for example, without removing the back side plate 374). As a result, the workability can be improved in maintenance or the like of the conveyance unit 380 that conveys the sheet S.

### Second Embodiment

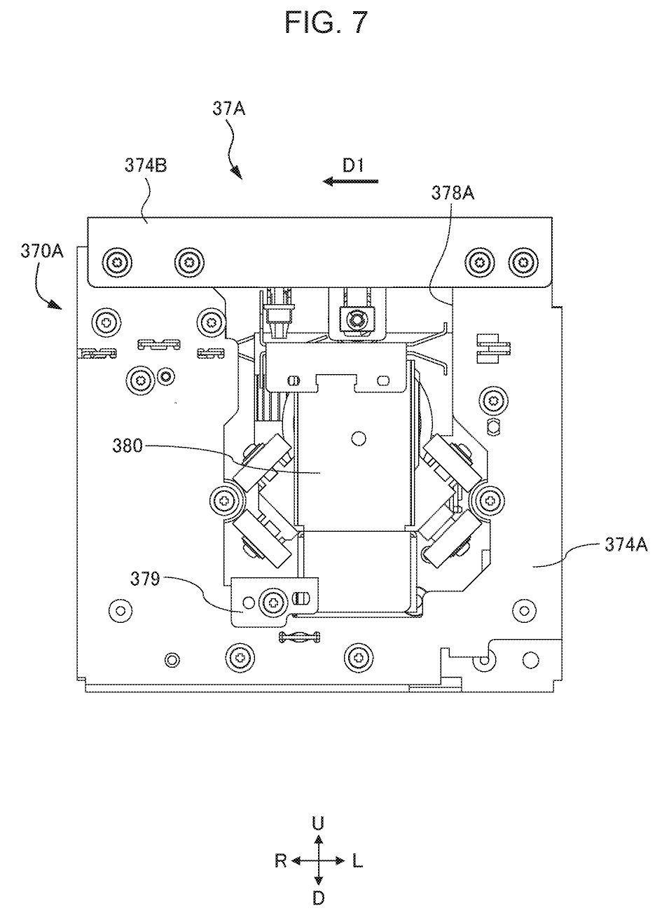

The second embodiment is described below with reference to FIG. 7. According to the present embodiment, unlike the first embodiment, an opening 378A is formed by a back side plate 374A and an auxiliary member 374B. The other configurations are similar to those according to the first embodiment and, therefore, the similar configurations are identified by the same reference numerals as in the first embodiment without further description.

FIG. 7 is a back view of a registration unit 37A according to the second embodiment. According to the present embodiment, a back side plate has a limited component size due to the positional relationship among the surrounding components. For this reason, the opening 378 cannot be provided in the back side plate consisting of a single component. Therefore, the back side plate may be divided, and the divided back side plates may be separately provided. However, in this case, a high rigidity of the support unit 370A cannot be maintained.

According to the present embodiment, an auxiliary member 374B is attached to the back side plate 374A to ensure the desired rigidity. The back side plate 374A has a substantially U-shape profile that is open upward, and the auxiliary member 374B is disposed to cross over the open part of the U-shape and is screwed to the back side plate 374A to reinforce the back side plate 374A. When the registration unit 37A is attached to the drying module 300 and is used, the back side plate 374A and the auxiliary member 374B are fastened together. When the conveyance unit 380 is extracted for maintenance, the opening 378A can be provided to separate the conveyance unit 380 by removing the auxiliary member 374B.

In FIG. 7, a stopper 379 is provided as in the first embodiment. However, the use for the stopper 379 may be eliminated by providing the auxiliary member 374B. Even in this case, the auxiliary member 374B functions as a stopper to prevent the conveyance unit 380 from falling off. That is, the auxiliary member 374B is an example of the restricting unit and is movable to one of a restricting position (refer to FIG. 7) where the movement of the conveyance unit 380 in the width direction W is restricted and a retracted position where the movement of the conveyance unit 380 is not restricted.

As described above, according to the present embodiment, the opening 378A is provided in the back side plate 374A, which constitutes the support unit 370A, to allow the conveyance unit 380 to pass therethrough when the conveyance unit 380 is attached or detached. This makes it possible to attach or detach the conveyance unit 380 without disassembling the support unit 370A (for example, without removing the back side plate 374A). As a result, the workability can be improved in maintenance or the like of the conveyance unit 380 that conveys the sheet S.

While the embodiments above have been described with reference to the first rail 372a and the second rail 372b provided in the support unit 370, the embodiments are not limited thereto. The first rail 372a and the second rail 372b may be provided in the conveyance unit 380. In this case, the support unit 370 is provided with rollers.

While the embodiments above have been described with reference to the case in which the first rail 372a and the second rail 372b are linear and, therefore, the conveyance unit 380 is linearly attached or detached along the first rail 372a and the second rail 372b, the embodiments are not limited thereto. The present disclosure is applicable even when the first rail 372a and the second rail 372b are not linear or even when no rails are provided. In such a case, the conveyance unit 380 can still be attached or detached without disassembling the support units 370 and 370A by allowing the conveyance unit 380 to pass through the openings 378 and 378A of the back side plates 374 and 374A, respectively.

While the embodiments above have been described with reference to the drying module 300 applied as a sheet conveyance apparatus, the embodiments are not limited thereto. For example, the embodiments can be widely applied to a skew correction apparatus of an image forming apparatus or a feeding deck or other sheet conveyance apparatuses. While the embodiments above have been described with reference to the image forming system applied to the inkjet printing system 1, the embodiments are not limited thereto. The embodiments may be applied to an electrophotographic image forming apparatus.

According to the present disclosure, workability can be improved in, for example, maintenance of a conveyance unit that conveys a sheet.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-207130, filed November 28, 2024, which is hereby incorporated by reference herein in its entirety.

What is claimed is:

1. A sheet conveyance apparatus comprising:
a housing; and
a detachable unit configured to be detachable from the housing,
wherein the detachable unit includes
a conveyance unit and a support unit configured to support the conveyance unit, wherein the conveyance unit includes
a conveyance roller pair configured to nip and convey a sheet, and a guide pair configured to guide the sheet,
wherein the support unit has an opening at one end in a width direction that is perpendicular to a sheet conveyance direction, and
wherein the conveyance unit is detached from the support unit by moving in the width direction and passing through the opening.

2. The sheet conveyance apparatus according to claim 1, wherein the opening has a size larger than a contour of the conveyance unit as viewed from the width direction when the conveyance unit is supported by the support unit.

3. The sheet conveyance apparatus according to claim 1, wherein the support unit includes a side edge member provided at one side in the width direction, and
wherein the opening is located in the side edge member.

4. The sheet conveyance apparatus according to claim 3, wherein the side edge member is disposed on a back side of the sheet conveyance apparatus, and
wherein the detachable unit is extractable toward a front side of the sheet conveyance apparatus.

5. The sheet conveyance apparatus according to claim 1, wherein the support unit includes a guide unit configured to support the conveyance unit in a movable manner in the width direction, and
wherein the conveyance unit includes a guided portion supported by the guide unit in a movable manner in the width direction.

6. The sheet conveyance apparatus according to claim 5, wherein the guide unit is a rail having a longitudinal direction that coincides with the width direction,
wherein the guided portion is a roller that is in rotatable contact with the rail, and
wherein a portion of the rail that is in contact with at least the roller overlaps the opening as viewed from the width direction when the conveyance unit is supported by the support unit.

7. The sheet conveyance apparatus according to claim 6, wherein the support unit includes a side edge member provided at the one end in the width direction,
wherein the opening is located in the side edge member, and
wherein one end of the rail is supported by the side edge member.

8. The sheet conveyance apparatus according to claim 6, wherein the rail is a first rail disposed upstream of a center of the conveyance unit in the sheet conveyance direction,
wherein the roller is a first roller that is in rotatable contact with the first rail,
wherein the sheet conveyance apparatus further comprises a second rail that is attached to the support unit at a position downstream of the center of the conveyance unit in the sheet conveyance direction and that is configured to support the conveyance unit in a movable manner in the width direction and
a second roller that is attached to the conveyance unit and that is in rotatable contact with the second rail, and
wherein the second roller and a portion of the second rail that is in contact with at least the second roller overlap the opening as viewed from the width direction when the conveyance unit is supported by the support unit.

9. The sheet conveyance apparatus according to claim 8, wherein the first rail and the second rail are disposed so that a longitudinal direction of the first rail and the second rail coincides with a horizontal direction,
wherein the first roller is disposed above a center of the first rail,
wherein the second roller is disposed above a center of the second rail,
wherein the sheet conveyance apparatus further comprises a third roller that is attached to the conveyance unit and is in rotatable contact with the first rail at a position below the center of the first rail, wherein the third roller and the first roller sandwich the first rail, and
a fourth roller that is attached to the conveyance unit and is in rotatable contact with the second rail at a position below the center of the second rail, wherein the fourth roller and the second roller sandwich the second rail, and
wherein the third roller and the fourth roller overlap the opening as viewed from the width direction when the conveyance unit is supported by the support unit.

10. The sheet conveyance apparatus according to claim 5, further comprising:
a drive unit configured to move the conveyance unit in the width direction relative to the support unit.

11. The sheet conveyance apparatus according to claim 10, wherein the drive unit includes
a drive section having a drive motor attached to the support unit and a pinion gear attached to a drive shaft of the drive motor and includes
a rack gear that is attached to the conveyance unit, and
wherein the pinion gear meshes with the rack gear when the conveyance unit is supported by the support unit.

12. The sheet conveyance apparatus according to claim 10, further comprising:
a width-direction detection unit configured to detect a position in the width direction of a sheet conveyed by the conveyance unit; and
a control unit configured to control the drive unit,
wherein the control unit controls the drive unit to change a position in the width direction of the sheet conveyed by the conveyance unit based on a result of detection performed by the width-direction detection unit.

13. The sheet conveyance apparatus according to claim 1, wherein
the conveyance roller pair is a first conveyance roller pair configured to nip and convey a sheet,
wherein the conveyance unit further includes
a second conveyance roller pair disposed at a different position from the first conveyance roller pair in the width direction and configured to nip and convey the sheet,
a first roller drive unit configured to drive the first conveyance roller pair, and
a second roller drive unit configured to drive the second conveyance roller pair.

14. The sheet conveyance apparatus according to claim 13, further comprising:
a skew detection unit configured to detect skew of a sheet conveyed by the conveyance unit; and
a control unit configured to control the first roller drive unit and the second roller drive unit,
wherein the control unit controls the first roller drive unit and the second roller drive unit to correct the skew of the sheet conveyed by the conveyance unit based on a result of detection performed by the skew detection unit.

15. The sheet conveyance apparatus according to claim 1, further comprising:
a restricting unit configured to restrict a movement of the conveyance unit to prevent the conveyance unit from dislodging from the support unit.

16. The sheet conveyance apparatus according to claim 15, wherein when attached to the support unit, the restricting unit at least partially overlaps the opening as the support unit is viewed from the width direction.

17. The sheet conveyance apparatus according to claim 1, further comprising:
an upstream unit disposed directly upstream of the support unit in the sheet conveyance direction and configured to convey a sheet to the conveyance unit; and
a downstream unit disposed directly downstream of the support unit in the sheet conveyance direction and configured to receive the sheet conveyed from the conveyance unit.

18. The sheet conveyance apparatus according to claim 17, wherein the upstream unit and the downstream unit are disposed to overlap the support unit as viewed from a horizontal direction,
wherein the support unit is supported by a lower portion of the housing, and
wherein the sheet conveyance apparatus further comprises an upper side unit disposed above the support unit.

19. An image forming system comprising:
an image forming apparatus including an image forming unit configured to form an image on a sheet; and
the sheet conveyance apparatus according to claim 1.
